(19) United States
(12) Patent Application Publication
(10) Pub. No.: US 2007/0201551 A1
(43) Pub. Date: Aug. 30, 2007

(54) System and apparatus for low-complexity fine granularity scalable video coding with motion compensation

(75) Inventors: Xianglin Wang, Irving, TX (US); Marta Karczewicz, Irving, TX (US); Justin Ridge, Sachse, TX (US); Nejib Ammar, Irving, TX (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/651,943

(22) Filed: Jan. 9, 2007

Related U.S. Application Data
(60) Provisional application No. 60/757,746, filed on Jan. 9, 2006.

(51) Int. Cl. H04B 1/66; H04N 11/04

(52) U.S. Cl. 375/240.1; 375/240.24

(57) ABSTRACT

A coding structure is configured to improve coding efficiency together with reduced encoding and decoding complexity for scalable video encoding. Especially, the case of coding multiple FGS layers on top of a discrete layer is considered. For coding multiple FGS layers, a decoder-oriented two-loop structure is used. At the decoder side, the new structure has similar complexity as the two-loop structure while providing similar coding performance as multi-loop structure. The coding structure and method is configured for preventing the drift effect in case of partial decoding due to the usage of FGS layer for inter-discrete-layer prediction, and aims at effectively utilizing temporal prediction in FGS layer coding to improve coding efficiency. The coding method can avoid additional transform operations; avoid applying in-loop de-blocking filter to FGS layers; and use simpler residual transform on FGS layers.

This patent application is based on and claims priority to U.S. patent application Ser. No. 60/757,746, filed Jan. 9, 2006, and assigned to the assignee of the present invention.

### FIELD OF THE INVENTION

This invention relates to the field of video coding, and more specifically to scalable video coding.

### BACKGROUND OF THE INVENTION

In video coding, temporal redundancy existing among video frames can be minimized by predicting a video frame based on other video frames. These other frames are called the reference frames. Temporal prediction can be carried out in different ways:

The decoder uses the same reference frames as those used by the encoder. This is the most common method in conventional non-scalable video coding. In normal operations, there should not be any mismatch between the reference frames used by the encoder and those by the decoder.

The encoder uses the reference frames that are not available to the decoder. One example is that the encoder uses the original frames instead of reconstructed frames as reference frames.

The decoder uses the reference frames that are only partially reconstructed compared to the frames used in the encoder. A frame is partially reconstructed if either the bitstream of the same frame is not fully decoded or its own reference frames are partially reconstructed.

When temporal prediction is carried out according to the second and the third methods, mismatch is likely to exist between the reference frames used by the encoder and those by the decoder. If the mismatch accumulates at the decoder side, the quality of reconstructed video suffers.

Mismatch in the temporal prediction between the encoder and the decoder is called a drift. Many video coding systems are designed to be drift-free because the accumulated errors could result in artifacts in the reconstructed video. Sometimes, in order to achieve certain video coding features, such as SNR scalability, more efficiently, drift is not always completely avoided.

A signal-to-noise ratio (SNR) scalable video stream has the property that the video of a lower quality level can be reconstructed from a partial bitstream. Fine granularity scalability (FGS) is one type of SNR scalability that the scalable stream can be arbitrarily truncated. FIG. 1 illustrates how a stream of FGS property is generated in MPEG-4. Firstly a base layer is coded in a non-scalable bitstream. FGS layer is then coded on top of that. MPEG-4 FGS does not exploit any temporal correlation within the FGS layer. As shown in FIG. 2, when no temporal prediction is used in FGS layer coding, the FGS layer is predicted from the base layer reconstructed frame. This approach has the maximal bitstream flexibility since truncation of the FGS stream of one frame will not affect the decoding of other frames, but the coding performance is not competitive.

It is desirable to introduce another prediction loop in the FGS layer coding to improve the coding efficiency. However, since the FGS layer of any frame can be partially decoded, the error caused by the difference between the reference frames used in the decoder and encoder will accumulate and the drift is resulted. This is illustrated in FIG. 3.

Leaky prediction is a technique that has been used to seek a balance between coding performance and drift control in SNR enhancement layer coding (see, for example, Huang et al. “A robust fine granularity scalability using trellis-based predictive leak”, IEEE Transaction on Circuits and Systems for Video Technology”, pp. 372-385, vol. 12, Issue 6, June 2002). To encode the FGS layer of the n^{th} frame, the actual reference frame is formed with a linear combination of the base layer reconstructed frame and the enhancement layer reference frame. If an enhancement layer reference frame is partially reconstructed in the decoder, the leaky prediction method will limit the propagation of the error caused by the mismatch between the reference frame used by the encoder and that used by the decoder. This is because the error will be attenuated every time a new reference signal is formed.

U.S. patent application Ser. No. 11/403,233 (hereafter referred to as U.S. Ser. No. 11/403,233) discloses a method that chooses a leaky factor adaptively based on the information coded in the base layer. With such a method, the temporal prediction is efficiently incorporated in FGS layer coding to improve coding performance and at the same time the drift can be effectively controlled. U.S. Ser. No. 11/403,233 discloses to: 1) perform interpolation on differential reference frame (i.e. difference between enhancement layer reference frame and base layer reference frame) with simpler interpolation method, e.g. bilinear, in motion compensation for FGS layer coding. 2) reduce the number of transform operations by applying the same leaky factor on blocks that have at least a certain number of non-zero coefficients. In U.S. Ser. No. 11/403,233, two coding structures for coding multiple FGS layers on top of a discrete base layer are also disclosed, namely two-loop structure and multi-loop structure.

According to the two-loop structure, as shown in FIG. 3, the first FGS layer of the current frame uses the discrete base layer as the “base layer” and the top-most FGS layer of the previously coded frame as the “enhancement layer”. As depicted in FIG. 3, the coding of the first FGS layer of the current frame n, uses the 3^{rd}, the top-most, enhancement layer of frame n−1 as the reference frame. Then higher FGS layers of the current frame, i.e., 2^{nd}, 3^{rd}, . . . , use the reconstructed lower FGS layers of the current frame as prediction, which is similar to the MPEG-4. According to such structure, a total of two loops of motion compensation are needed for coding a FGS layer.

According to multi-loop structure, the encoder performs the following:
The first coding loop is to reconstruct the discrete base layer frames.
The second coding loop is to reconstruct the first FGS layer. The “base layer” is the discrete base layer and the “enhancement layer” is the first FGS layer of the reference frame.
In the third coding loop is to reconstruct the second FGS layer where the “base layer is the first FGS layer of the same frame from the second coding loop and the “enhancement layer is the second FGS layer of the reference frame, and so on.

The multi-loop structure is shown in FIG. 4.

Since additional motion compensation is needed in coding each FGS layer, this is significantly more complex than two-loop structure. Generally for coding the m-th FGS layer, (m+1) loops of motion compensation are needed.

In the scenarios described above, only one discrete layer is considered. When more than one discrete layer is available with FGS layers on top of the discrete layers, additional issues can arise. A discrete enhancement layer can be a spatial enhancement layer. It can also be a SNR enhancement layer that is different from FGS layer, such as CGS (coarse granularity scalability) layer.

FIG. 6 shows an example, wherein two discrete layers are coded and the enhancement discrete layer is a spatial enhancement layer. One FGS layer is also available on top of the discrete base layer. In this case, since the spatial enhancement layer is partially predicted from the FGS layer, drift effect can be expected at the spatial enhancement layer in case of partial decoding of FGS layer at the decoder side. According to the current SVC standard, the prediction between different discrete layers includes but not limited to:
1. Texture prediction, also called intra-base mode. The reconstructed base layer block is used to predict an enhancement layer block.
2. Residual prediction. The reconstructed base layer block prediction residual is used to predict enhancement layer block prediction residual.

### SUMMARY OF THE INVENTION

The present invention provides a method and system for coding multiple FGS layers, wherein a decoder-oriented two-loop structure is used. At the decoder side, the new structure has similar complexity as the two-loop structure while providing similar coding performance as multi-loop structure. The present invention also provides a method for preventing the drift effect in case of partial decoding due to the usage of FGS layer for inter-discrete-layer prediction. The present invention aims at effectively utilizing temporal prediction in FGS layer coding to improve coding efficiency

Thus, the first aspect of the present invention is a method of encoding a frame of a digital video sequence or decoding an encoded digital video sequence to generate discrete-base layer frames and a plurality of enhancement layer frames, each said frames comprising an array of pixels divided into a plurality of blocks. The method comprises:

determining a prediction for coding an enhancement layer of a current block of a current frame based on both a reference block used for a collocated block of the current block at a discrete base layer and a reference block for the current block at a same enhancement layer in a previously coded frame;

calculating a sum of prediction residuals of the current block from all of lower layers; and

forming a reference block for coding said enhancement layer by adding said sum of prediction residuals to said prediction.

According to the present invention, the collocated block of the current block of the discrete base layer has one or more coefficients, and if all of said one or more coefficients of the collocated block in the discrete base layer are zero, the prediction of the current block is calculated as a weighted average of the reference block in the discrete base layer and the reference block in the enhancement layer.

According to the present invention, if the number of non-zero coefficients in the collocated block in the discrete base layer exceeds a predetermined threshold, then all of said one or more coefficients in the current block use a single leaky factor, said leaky factor is determined based on the number of nonzero coefficients in the discrete base layer, and the prediction of the current block is a weighted average of the reference block in discrete base layer and the reference block in enhancement layer; and

if the number of non-zero coefficients in the collocated block in the discrete base layer is greater than zero and the number is below or equal to a predetermined threshold, the prediction is formed in transform coefficient domain as a weighted average of the transform coefficients of the reference block in the discrete base layer and the transform coefficients of the reference block in enhancement layer.

The predetermined threshold value can be set to 0.

The present invention also provides a method of encoding a frame of a digital video sequence or decoding an encoded digital video sequence to generate discrete-enhancement frames based on discrete-base layer frames and plurality of non-discrete enhancement layer frames on top of the discrete-base layer frames, each said frames comprising an array of pixels divided into a plurality of blocks. The encoding method comprises forming a prediction for a discrete-enhancement layer frame either from its discrete-base layer frame or any one of the lower enhancement layer frames; and indicating in the bitstream if said prediction is formed from its discrete-base layer frame or one of the lower enhancement layer frames. The decoding method comprises receiving in the bitstream an indication whether a prediction for coding an enhancement layer of a current block of a current frame is from a discrete-base layer frame or from one of the lower enhancement layer frames; and forming a prediction for decoding the current discrete enhancement layer frame either from its discrete base layer frame or from one of the lower enhancement layer frames based on the received information.

The second aspect of the present invention is an encoder for encoding a frame of a digital video sequence to generate discrete-base layer frames and a plurality of enhancement layer frames, each said frames comprising an array of pixels divided into a plurality of blocks. The encoder comprises:

a module for determining a prediction for coding an enhancement layer of a current block of a current frame based on both a reference block used for a collocated block of the current block at a discrete base layer and a reference block for the current block at a same enhancement layer in a previously coded frame;

a module for calculating a sum of prediction residuals of the current block from all of lower layers; and

a module for forming a reference block for coding said enhancement layer by adding said sum of prediction residuals to said prediction.

The third aspect of the present invention is a decoder for decoding an encoded digital video sequence to generate discrete-base layer frames and plurality of enhancement layer frames, each said frames comprising an array of pixels divided into a plurality of blocks. The decoder comprises:

a module for determining a prediction for coding an enhancement layer of a current block of a current frame based on both a reference block used for a collocated block of the current block at a discrete base layer and a reference block for the current block at a same enhancement layer in a previously coded frame;

a module for calculating a sum of prediction residuals of the current block from all of lower layers; and

a module for forming a reference block for coding said enhancement layer by adding said sum of prediction residuals to said prediction.

The fourth aspect of the present invention is a device, such as a mobile phone, having an encoder and a decoder as described above.

The fifth aspect of the present invention is a software application product comprising a computer readable storage medium having a software application for use in encoding a digital video sequence or decoding an encoded digital video sequence, the software application has programming codes to carry out the encoding and decoding method as described above.

### BRIEF DESCRIPTION OF THE DRAWINGS

FIG. 1 illustrates fine granularity scalability with no temporal prediction in an FGS layer according to MPEG-4.

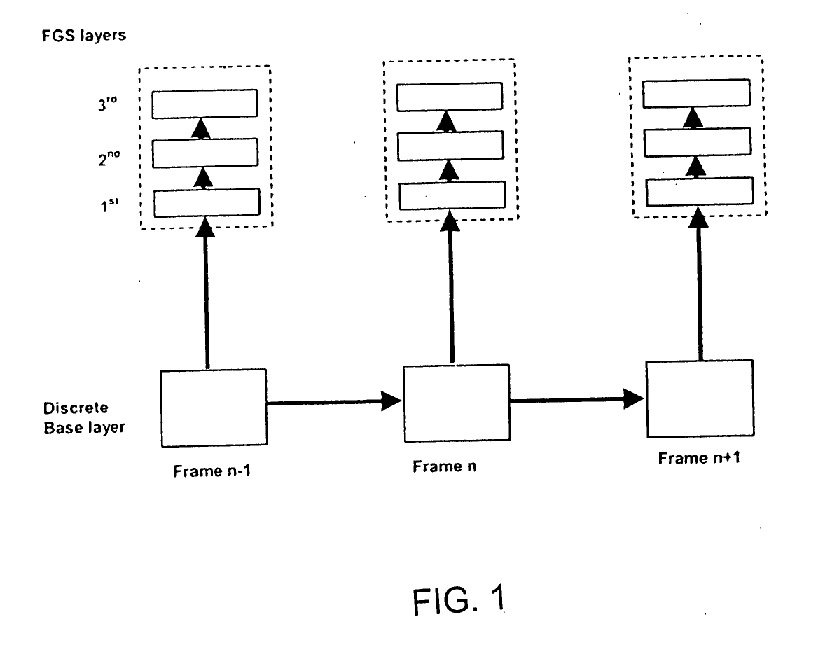

FIG. 2 illustrates fine granularity scalability with temporal prediction in an FGS layer.

FIG. 3 illustrates fine granularity scalability with temporal prediction in FGS layers in a two-loop structure.

FIG. 4 illustrates fine granularity scalability with temporal prediction in FGS layers in a multi-loop structure.

FIG. 5 illustrates fine granularity scalability with temporal prediction in FGS layers in a decoder-oriented two-loop structure, according to the present invention.

FIG. 6 illustrates an example of multiple discrete layers together with FGS layers.

FIG. 7 illustrates an FGS encoder with base-layer-dependent formation of reference block.

FIG. 8 illustrates an FGS decoder with base-layer-dependent formation of reference block.

FIG. 9 illustrates an electronic device having at least one of the scalable encoder and the scalable decoder, according to the present invention.

### DETAILED DESCRIPTION OF THE PREFERRED EMBODIMENTS

The various embodiments of the present invention provides a coding structure and a method for an improved coding efficiency together with reduced encoding and decoding complexity for scalable video encoding. Especially, the case of coding multiple FGS layers on top of a discrete layer is considered.

For coding multiple FGS layers, a decoder-oriented two-loop structure is used. At the decoder side, the new structure has similar complexity as the two-loop structure while providing similar coding performance as multi-loop structure.

The various embodiments of the present invention also provides a method for preventing the drift effect in case of partial decoding due to the usage of FGS layer for inter-discrete-layer prediction.

The present invention aims at effectively utilizing temporal prediction in FGS layer coding to improve coding efficiency. However, incorporating temporal information into prediction for FGS layer coding may also result in the drift problem in case of partial decoding of FGS frame at the decoder side. How to efficiently utilize temporal information for prediction in FGS layer coding while also controlling the drift effect is the main focus of the present invention.

When FGS layer is used as a prediction for a higher discrete layer, the prediction drift in case of partial decoding of FGS layer can significantly affect the coding performance.

Further Simplifications to Previous Solutions

A. Avoiding Additional Transform Operations

In the method described in U.S. Ser. No. 11/403,233, generally the following three cases are considered when forming a prediction for coding a block in FGS layer.
a) If all the coefficients of its collocated block in base layer are zero, the prediction of the current block is calculated as a weighted average of the reference block in the base layer and the reference block in the enhancement layer. In this case, the averaging operation can be performed in spatial domain and no additional transform operation is needed.
b) If the number of non-zero coefficients in its collocated block in base layer exceeds a certain threshold, Tc, then all the coefficients in this block use a single leaky factor. The value of leaky factor may depend on the number of nonzero coefficients in the base layer. In this case, the prediction of the current block is also a weighted average of the reference block in base layer and the reference block in enhancement layer. The averaging operation can be performed in spatial domain and no transform is needed.
c) If the number of non-zero coefficients in its collocated block in the base layer is not zero and does not exceed the threshold, Tc, then transform is performed and different leaky factors may be applied to different coefficients.

As a special case as well as a simplification mechanism, case (c) can be simply merged into case (b) by setting threshold Tc to 0. As a result, no additional transform is needed in this method. Since most complexity of the algorithm is associated with the processing in case (c), eliminating case (c) can significant simplify the overall algorithm complexity. Especially when multi-loop structure is used for coding multiple FGS layers, such a simplification is desired and should generally be applied.

B. Not Applying In-Loop De-Blocking Filter to FGS Layers

In H.264, an in-loop de-blocking filter is designed and can be applied to reduce block artifacts around coding block boundary. Such a filter is called a loop filter. It can be used not only to reduce block artifacts, but also to boost coding performance because a better (i.e. filtered) frame can be used as reference frame for coding subsequent frames. However, the use of loop filter also significantly increases overall coding complexity, especially for the case of multi-loop structure.

A feasible method of reducing complexity is to allow an in-loop filter only for the discrete base layer. For FGS layers on top of this discrete base layer, no in-loop filter is applied. For the final FGS layer, i.e. the final reconstructed FGS layer at the decoder side, loop filter can be optionally applied as a post filter. This means that after the final FGS layer is decoded the filter can be optionally applied to the decoded sequence to remove block artifacts, but the filtered FGS frame is not involved in the coding loop.

C. Using Simpler Residual Transform on FGS Layers

To further reduce complexity, simpler residual transforms can be used for FGS layer coding. In H.264, an integer transform based on DCT is defined and used for residual transform. However, it is found that using a simpler transform, such as a 4×4 Hadamard transform, as residual transform does not bring obvious coding performance degradation. The 4×4 Hadamard transform is much simpler than the integer transform based on DCT.

Decoder Oriented Two-Loop Structure for Coding Multiple FGS Layers

In U.S. Ser. No. 11/403,233, both a two-loop structure and a multi-loop structure are disclosed for coding multiple FGS layers on top of a discrete base layer. However, each of the two structures has some drawbacks.

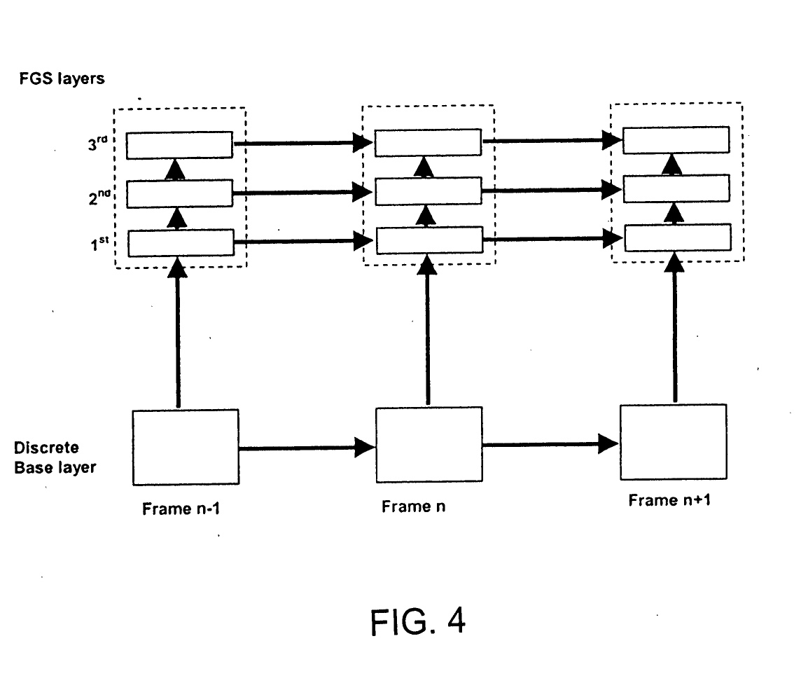

For multi-loop structure, the problem is its complexity. As shown in FIG. 4, according to multi-loop structure the prediction of each FGS layer is formed from its base layer and the same FGS layer of its reference frame. FGS layers need to be coded one by one sequentially. At the encoder side, after the discrete base layer is encoded, the first FGS layer can be encoded. The second FGS layer can be encoded only after the first FGS layer has been encoded and so on. The situation is the same for decoder. At decoder side, after the discrete base layer is decoded, the first FGS layer can be decoded. Then the second FGS layer and then the third . . . So for example in order to reconstruct the third FGS layer at the decoder side, each of the discrete base layers, the first FGS layer and the second FGS layer has to be decoded and reconstructed. Motion compensation is also needed in decoding each of the lower layers as well as the current layer.

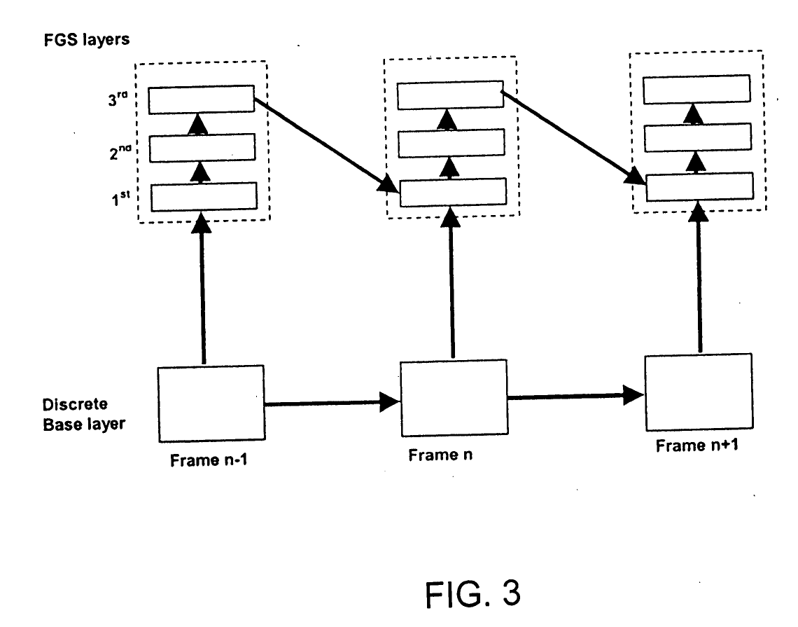

Two-loop structure has much lower complexity than multi-loop structure because it requires only two loops of motion compensation for coding an FGS layer, regardless of which FGS layer it is. As shown in FIG. 3, when coding the first FGS layer, the discrete base layer and the top-most FGS layer of its reference frame are used to form the prediction. When coding the second FGS layer, the reconstructed first FGS layer frame is used as prediction and therefore no more motion compensation is needed. Similarly, when coding the third FGS layer, the reconstructed second FGS layer frame is used as prediction and so on. So in total, two loops of motion compensation are needed for coding an FGS layer. Such situation is the same for both the encoder and the decoder.

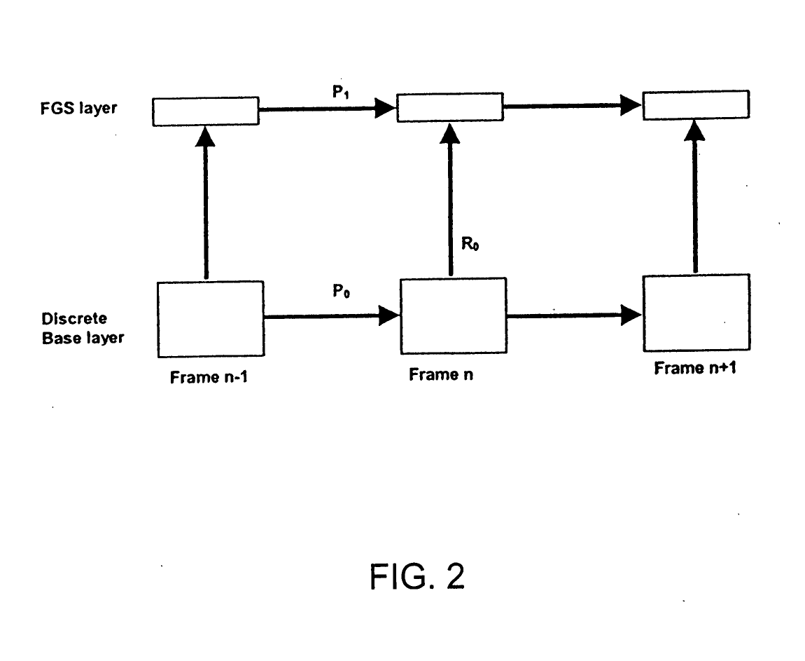

However, for two-loop structure, the problem is its performance. Since the prediction is formed from the discrete base layer of the current frame and the top-most FGS layer of its reference frame when coding a first FGS layer frame, prediction drift can be expected in case of partial decoding of FGS layer. For instance, assume three FGS layers are coded according to FIG. 3 at the encoder side. When only decoding the first FGS layer at the decoder side, the prediction for the first FGS layer would be formed in a way shown in FIG. 2. In this case, only the first FGS layer is available for each decoded frame and therefore this layer (i.e. top-most layer available) is used for FGS layer prediction. This is different from the case at encoder side where the third FGS layer frame is used for prediction. The mismatch between predictors used at encoder side and decoder side causes the drift effect. As a result, the coding performance of the first FGS layer as well as the second FGS layer can be dramatically affected.

In the various embodiments of the present invention, a new two-loop structure is presented. According to the new two-loop coding structure, multi-loop motion compensation may still be used at the encoder side, but at the decoder side only two-loop motion compensation may be used. For this reason, this structure is referred to as a decoder-oriented two-loop structure in the following description of the various embodiments of the invention.

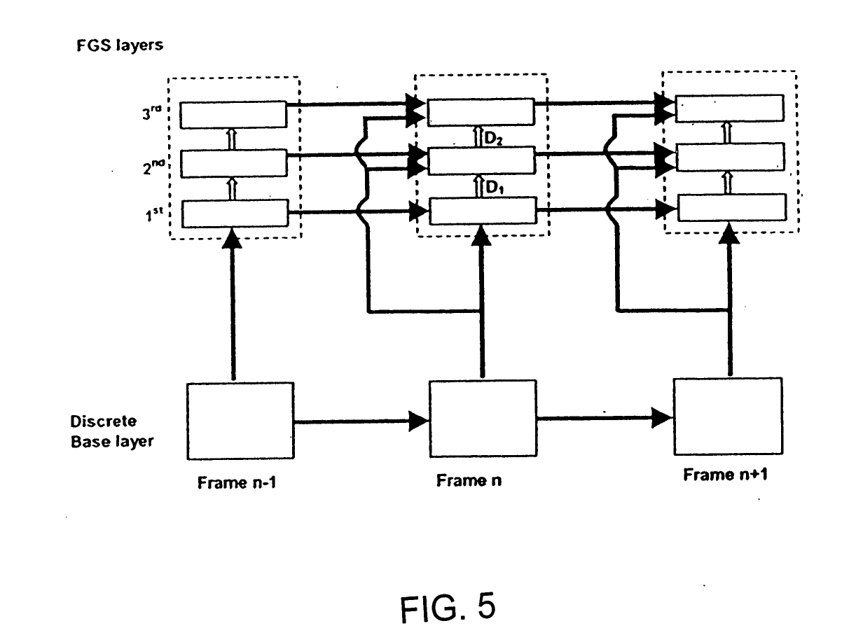

The temporal prediction of FGS layer frame is formed as illustrated in FIG. 5. The prediction of the first FGS layer, P₁, is formed in the same way as that in multi-loop coding structure according to the FGS coding method disclosed in U.S. Ser. No. 11/403,233. For the second FGS layer, an initial prediction, P₂′, is first calculated according to the same FGS coding method proposed, but using the discrete base layer as “base layer” and the second FGS layer as “enhancement layer”. Then P₂′ is added with the first FGS layer reconstructed prediction residual D₁ (which is indicated with hollow arrow in FIG. 5) and the sum, P₂, is used as actual prediction.
P₂=P₂′+α*D₁
α is a parameter and 0≦α≦1. Similarly, for the third FGS layer, an initial prediction, P₃′, is first calculated according to the same FGS coding method, but using the discrete base layer as “base layer” and the third FGS layer as “enhancement layer”. Then P₃′ is added with both the first and the second FGS layer reconstructed prediction residual D₁ and D₂ and the sum, P₃, is used as actual prediction.
P₃=P₃′+αD₁+β*D₂
β is also a parameter and 0≦β≦1. β can either be the same as or different from α Usually both α and β may be set as 1.

The difference between the decoder oriented two-loop structure and the multi-loop structure is that, in the decoder-oriented two-loop structure, the prediction of each FGS layer is formed from the discrete base layer of the current frame and the same FGS layer of its reference frame, whereas, in the multi-loop structure, the prediction of each FGS layer is formed from its immediate base layer.

With the decoder oriented two-loop structure, multi-loop motion compensation is still needed at the encoder side. After the discrete base layer is encoded, the first FGS layer is then encoded. The second FGS layer can be encoded only after the first FGS layer has been encoded and so on. Motion compensation is needed in encoding each FGS layer. However, at the decoder side, only two loops of motion compensation are needed for decoding an FGS layer regardless of which FGS layer it is, one at the discrete base layer and one at the current FGS layer. For example, in order to decode the second FGS layer, the discrete base layer is first decoded with motion compensation. Then the first FGS layer residual is decoded and no motion compensation is needed. Finally the second FGS layer is decoded with motion compensation according to the structure shown in FIG. 5.

It should be noted that for temporal prediction in FGS layers, FGS layer may use the same motion vectors of its discrete base layer. However, FGS layer may also use different motion vectors from its base layer. In either case, the proposed FGS coding method as well as the coding structure for multiple FGS layers is applicable.

It should also be noted that, in the present invention, the choice of the two-loop or multi-loop or decoder oriented two-loop coding structure can be an encoder choice and signaled in the bitstream. Therefore, it is possible that, in a sequence, different frames (or slices) are coded according to different coding structure and the selection of coding structure is signaled for each frame (or slice).

Preventing Drift Effect at Discrete Enhancement Layer Due to FGS Partial Decoding

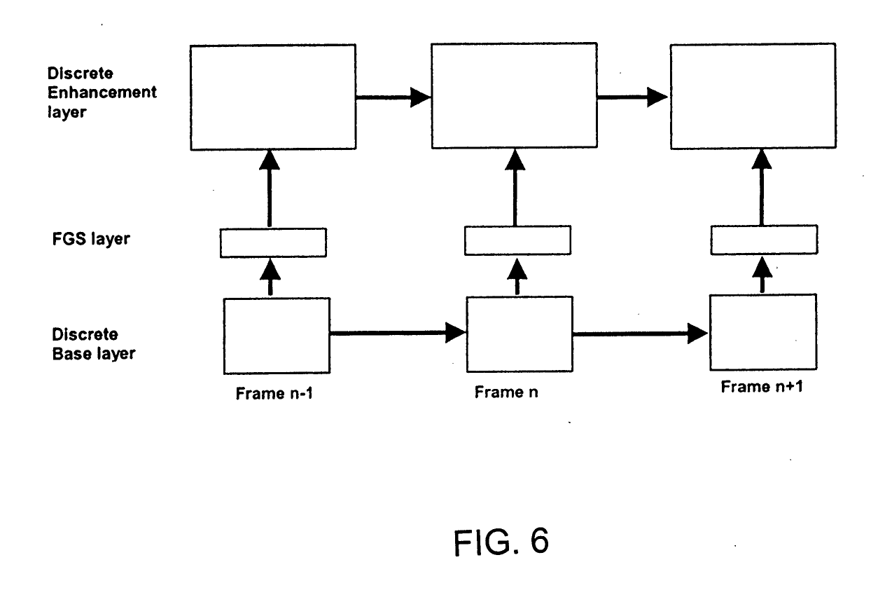

When an FGS layer is available and used to predict a higher discrete layer, as shown in FIG. 6, prediction drift problem can be expected in case of FGS layer partial decoding. Such drift effect can significantly affect the coding performance. However, if the discrete base layer, instead of the FGS layer, is used for prediction, the coding performance is also affected, because the discrete base layer has lower picture quality than the FGS layer.

A practical method to overcome such prediction drift is to use additional signal (or flag bit) to signal to the decoder that the prediction to a certain discrete enhancement layer should come from discrete base layer instead of an FGS layer on top of the discrete base layer. Since the discrete base layer is always guaranteed to be available and decoded, there is no prediction drift in this case. Meanwhile, such flag is only enabled from time to time, but not always. So, for most of the time, the FGS layer can still be used in prediction for better coding performance. Essentially, such signal (or flag bit) provides periodic refresh to the decoder in terms of how to get prediction for an enhancement discrete layer to prevent accumulated prediction drift effect.

There are different ways in coding the flag bits. It can be signaled at frame level (i.e. slice header according to H.264). So, for a certain frame (or slice), all blocks at a discrete enhancement layer use discrete base layer for prediction. It can also be signaled at macro-block level. In this case, only those macroblocks of a discrete enhancement layer that get signaled use the discrete base layer for prediction. Otherwise, the FGS layer of discrete base layer can be used for prediction.

The various embodiments of the present invention uses a decoder-oriented two-loop structure for coding multiple FGS layers. This two-loop structure has the same decoder complexity as the two-loop structure as shown in FIG. 3, but it can offer comparable coding performance as that of multi-loop structure, as shown in FIG. 4.

When the FGS layer is available and used to predict a higher discrete layer, the present invention provides a solution to the prediction drift problem due to FGS layer partial decoding.

Overview of the FGS Coder

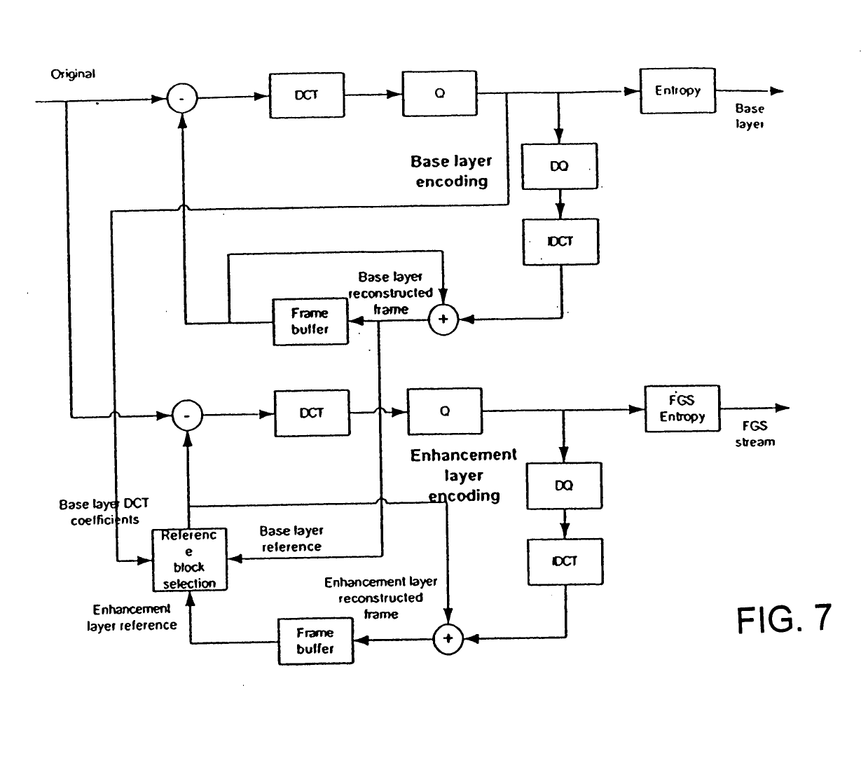

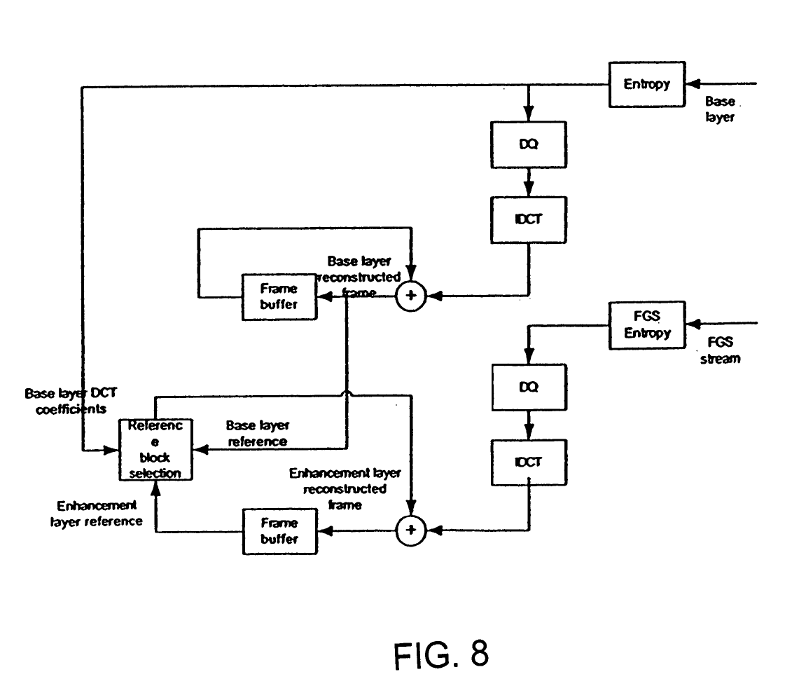

FIGS. 7 and 8 are block diagrams of the FGS encoder and decoder of the present invention wherein the formation of reference blocks is dependent upon the base layer. In these block diagrams, only one FGS layer is shown. However, it should be appreciated that the extension of one FGS layer to a structure having multiple FGS layers is straightforward.

As can be seen from the block diagrams, the FGS coder is a 2-loop video coder with an additional “reference block formation module”.

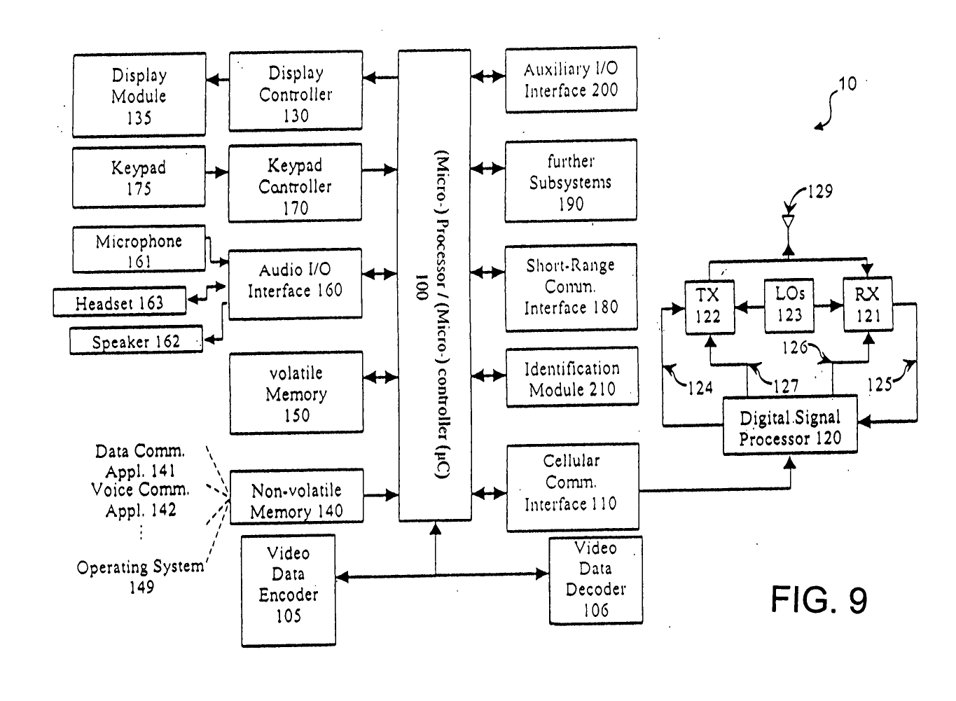

FIG. 9 depicts a typical mobile device according to an embodiment of the present invention. The mobile device 10 shown in FIG. 9 is capable of cellular data and voice communications. It should be noted that the present invention is not limited to this specific embodiment, which represents one of a multiplicity of different embodiments. The mobile device 10 includes a (main) microprocessor or microcontroller 100 as well as components associated with the microprocessor controlling the operation of the mobile device. These components include a display controller 130 connecting to a display module 135, a non-volatile memory 140, a volatile memory 150 such as a random access memory (RAM), an audio input/output (I/O) interface 160 connecting to a microphone 161, a speaker 162 and/or a headset 163, a keypad controller 170 connected to a keypad 175 or keyboard, any auxiliary input/output (I/O) interface 200, and a short-range communications interface 180. Such a device also typically includes other device subsystems shown generally at 190.

The mobile device 10 may communicate over a voice network and/or may likewise communicate over a data network, such as any public land mobile network (PLMN) in form of e.g. digital cellular networks, especially GSM (global system for mobile communication) or UMTS (universal mobile telecommunications system). Typically the voice and/or data communication is operated via an air interface, i.e. a cellular communication interface subsystem in cooperation with further components (see above) to a base station (BS) or node B (not shown) being part of a radio access network (RAN) of the infrastructure of the cellular network. The cellular communication interface subsystem as depicted illustratively in FIG. 9 comprises the cellular interface 110, a digital signal processor (DSP) 120, a receiver (RX) 121, a transmitter (TX) 122, and one or more local oscillators (LOs) 123 and enables the communication with one or more public land mobile networks (PLMNs). The digital signal processor (DSP) 120 sends communication signals 124 to the transmitter (TX) 122 and receives communication signals 125 from the receiver (RX) 121. In addition to processing communication signals, the digital signal processor 120 also provides for receiver control signals 126 and transmitter control signal 127. For example, besides the modulation and demodulation of the signals to be transmitted and signals received, respectively, the gain levels applied to communication signals in the receiver (RX) 121 and transmitter (TX) 122 may be adaptively controlled through automatic gain control algorithms implemented in the digital signal processor (DSP) 120. Other transceiver control algorithms could also be implemented in the digital signal processor (DSP) 120 in order to provide more sophisticated control of the transceiver 122. In case the mobile device 10 communications through the PLMN occur at a single frequency or a closely-spaced set of frequencies, then a single local oscillator (LO) 123 may be used in conjunction with the transmitter (TX) 122 and receiver (RX) 121. Alternatively, if different frequencies are utilized for voice/data communications or transmission versus reception, then a plurality of local oscillators can be used to generate a plurality of corresponding frequencies. Although the mobile device 10 depicted in FIG. 9 is used with the antenna 129 as or with a diversity antenna system (not shown), the mobile device 10 could be used with a single antenna structure for signal reception as well as transmission. Information, which includes both voice and data information, is communicated to and from the cellular interface 110 via a data link between the digital signal processor (DSP) 120. The detailed design of the cellular interface 110, such as frequency band, component selection, power level, etc., will be dependent upon the wireless network in which the mobile device 100 is intended to operate.

After any required network registration or activation procedures, which may involve the subscriber identification module (SIM) 210 required for registration in cellular networks, have been completed, the mobile device 10 may then send and receive communication signals, including both voice and data signals, over the wireless network. Signals received by the antenna 129 from the wireless network are routed to the receiver 121, which provides for such operations as signal amplification, frequency down conversion, filtering, channel selection, and analog to digital conversion. Analog to digital conversion of a received signal allows more complex communication finctions, such as digital demodulation and decoding, to be performed using the digital signal processor (DSP) 120. In a similar manner, signals to be transmitted to the network are processed, including modulation and encoding, for example, by the digital signal processor (DSP) 120 and are then provided to the transmitter 122 for digital to analog conversion, frequency up conversion, filtering, amplification, and transmission to the wireless network via the antenna 129.

The microprocessor/microcontroller (μC) 110, which may also be designated as a device platform microprocessor, manages the finctions of the mobile device 10. Operating system software 149 used by the processor 110 is preferably stored in a persistent store such as the non-volatile memory 140, which may be implemented, for example, as a Flash memory, battery backed-up RAM, any other non-volatile storage technology, or any combination thereof. In addition to the operating system 149, which controls low-level functions as well as (graphical) basic user interface functions of the mobile device 10, the non-volatile memory 140 includes a plurality of high-level software application programs or modules, such as a voice communication software application 142, a data communication software application 141, an organizer module (not shown), or any other type of software module (not shown). These modules are executed by the processor 100 and provide a high-level interface between a user of the mobile device 10 and the mobile device 10. This interface typically includes a graphical component provided through the display 135 controlled by a display controller 130 and input/output components provided through a keypad 175 connected via a keypad controller 170 to the processor 100, an auxiliary input/output (I/O) interface 200, and/or a short-range (SR) communication interface 180. The auxiliary I/O interface 200 comprises especially USB (universal serial bus) interface, serial interface, MMC (multimedia card) interface and related interface technologies/standards, and any other standardized or proprietary data communication bus technology, whereas the short-range communication interface radio frequency (RF) low-power interface includes especially WLAN (wireless local area network) and Bluetooth communication technology or an IRDA (infrared data access) interface. The RF low-power interface technology referred to herein should especially be understood to include any IEEE 801.xx standard technology, which description is obtainable from the Institute of Electrical and Electronics Engineers. Moreover, the auxiliary I/O interface 200 as well as the short-range communication interface 180 may each represent one or more interfaces supporting one or more input/output interface technologies and communication interface technologies, respectively. The operating system, specific device software applications or modules, or parts thereof, may be temporarily loaded into a volatile store 150 such as a random access memory (typically implemented on the basis of DRAM (direct random access memory) technology for faster operation). Moreover, received communication signals may also be temporarily stored to volatile memory 150, before permanently writing them to a file system located in the non-volatile memory 140 or any mass storage preferably detachably connected via the auxiliary I/O interface for storing data. It should be understood that the components described above represent typical components of a traditional mobile device 10 embodied herein in the form of a cellular phone. The present invention is not limited to these specific components and their implementation depicted merely for illustration and for the sake of completeness.

An exemplary software application module of the mobile device 10 is a personal information manager application providing PDA functionality including typically a contact manager, calendar, a task manager, and the like. Such a personal information manager is executed by the processor 100, may have access to the components of the mobile device 10, and may interact with other software application modules. For instance, interaction with the voice communication software application allows for managing phone calls, voice mails, etc., and interaction with the data communication software application enables for managing SMS (soft message service), MMS (multimedia service), e-mail communications and other data transmissions. The non-volatile memory 140 preferably provides a file system to facilitate permanent storage of data items on the device including particularly calendar entries, contacts etc. The ability for data communication with networks, e.g. via the cellular interface, the short-range communication interface, or the auxiliary I/O interface enables upload, download, and synchronization via such networks.

The application modules 141 to 149 represent device functions or software applications that are configured to be executed by the processor 100. In most known mobile devices, a single processor manages and controls the overall operation of the mobile device as well as all device functions and software applications. Such a concept is applicable for today's mobile devices. The implementation of enhanced multimedia functionalities includes, for example, reproducing of video streaming applications, manipulating of digital images, and video sequences captured by integrated or detachably connected digital camera functionality. The implementation may also include gaming applications with sophisticated graphics driving the requirement of computational power. One way to deal with the requirement for computational power, which has been pursued in the past, solves the problem for increasing computational power by implementing powerful and universal processor cores. Another approach for providing computational power is to implement two or more independent processor cores, which is a well known methodology in the art. The advantages of several independent processor cores can be immediately appreciated by those skilled in the art. Whereas a universal processor is designed for carrying out a multiplicity of different tasks without specialization to a pre-selection of distinct tasks, a multi-processor arrangement may include one or more universal processors and one or more specialized processors adapted for processing a predefined set of tasks. Nevertheless, the implementation of several processors within one device, especially a mobile device such as mobile device 10, requires traditionally a complete and sophisticated re-design of the components.

In the following, the present invention will provide a concept which allows simple integration of additional processor cores into an existing processing device implementation enabling the omission of expensive complete and sophisticated redesign. The inventive concept will be described with reference to system-on-a-chip (SoC) design. System-on-a-chip (SoC) is a concept of integrating at least numerous (or all) components of a processing device into a single high-integrated chip. Such a system-on-a-chip can contain digital, analog, mixed-signal, and often radio-frequency functions—all on one chip. A typical processing device comprises a number of integrated circuits that perform different tasks. These integrated circuits may include especially microprocessor, memory, universal asynchronous receiver-transmitters (UARTs), serial/parallel ports, direct memory access (DMA) controllers, and the like. A universal asynchronous receiver-transmitter (UART) translates between parallel bits of data and serial bits. The recent improvements in semiconductor technology caused that very-large-scale integration (VLSI) integrated circuits enable a significant growth in complexity, making it possible to integrate numerous components of a system in a single chip. With reference to FIG. 9, one or more components thereof, e.g. the controllers 130 and 160, the memory components 150 and 140, and one or more of the interfaces 200, 180 and 110, can be integrated together with the processor 100 in a signal chip which forms finally a system-on-a-chip (Soc).

Additionally, said device 10 is equipped with a module for scalable encoding 105 and scalable decoding 106 of video data according to the inventive operation of the present invention. By means of the CPU 100 said modules 105, 106 may individually be used. However, said device 10 is adapted to perform video data encoding or decoding respectively. Said video data may be received by means of the communication modules of the device or it also may be stored within any imaginable storage means within the device 10.

In sum, the present invention provides a method and system for coding multiple FGS layers, wherein a decoder-oriented two-loop structure is used. At the decoder side, the new structure has similar complexity as the two-loop structure while providing similar coding performance as multi-loop structure. The present invention also provides a method for preventing the drift effect in case of partial decoding due to the usage of FGS layer for inter-discrete-layer prediction. The present invention aims at effectively utilizing temporal prediction in FGS layer coding to improve coding efficiency

The present invention provides a method of encoding a frame of a digital video sequence or decoding an encoded digital video sequence to generate discrete-base layer frames and a plurality of enhancement layer frames, each said frames comprising an array of pixels divided into a plurality of blocks. The method comprises:

determining a prediction for coding an enhancement layer of a current block of a current frame based on both a reference block used for a collocated block of the current block at a discrete base layer and a reference block for the current block at a same enhancement layer in a previously coded frame;

calculating a sum of prediction residuals of the current block from all of lower layers; and

forming a reference block for coding said enhancement layer by adding said sum of prediction residuals to said prediction.

According to the present invention, the collocated block of the current block of the discrete base layer has one or more coefficients, and if all of said one or more coefficients of the collocated block in the discrete base layer are zero, the prediction of the current block is calculated as a weighted average of the reference block in the discrete base layer and the reference block in the enhancement layer.

According to the present invention, if the number of non-zero coefficients in the collocated block in the discrete base layer exceeds a predetermined threshold, then all of said one or more coefficients in the current block use a single leaky factor, said leaky factor is determined based on the number of nonzero coefficients in the discrete base layer, and the prediction of the current block is a weighted average of the reference block in discrete base layer and the reference block in enhancement layer; and

if the number of non-zero coefficients in the collocated block in the discrete base layer is greater than zero and the number is below or equal to a predetermined threshold, the prediction is formed in transform coefficient domain as a weighted average of the transform coefficients of the reference block in the discrete base layer and the transform coefficients of the reference block in enhancement layer.

The predetermined threshold value can be set to 0.

The present invention also provides a method of encoding a frame of a digital video sequence or decoding an encoded digital video sequence to generate discrete-enhancement frames based on discrete-base layer frames and plurality of non-discrete enhancement layer frames on top of the discrete-base layer frames, each said frames comprising an array of pixels divided into a plurality of blocks. The encoding method comprises forming a prediction for a discrete-enhancement layer frame either from its discrete-base layer frame or any one of the lower enhancement layer frames; and indicating in the bitstream if said prediction is formed from its discrete-base layer frame or one of the lower enhancement layer frames. The decoding method comprises receiving in the bitstream an indication whether a prediction for coding an enhancement layer of a current block of a current frame is from a discrete-base layer frame or from one of the lower enhancement layer frames; and forming a prediction for decoding the current discrete enhancement layer frame either from its discrete base layer frame or from one of the lower enhancement layer frames based on the received information.

The present invention provides an encoder for encoding a frame of a digital video sequence to generate discrete-base layer frames and a plurality of enhancement layer frames, each said frames comprising an array of pixels divided into a plurality of blocks.

The encoder comprises:

a module for determining a prediction for coding an enhancement layer of a current block of a current frame based on both a reference block used for a collocated block of the current block at a discrete base layer and a reference block for the current block at a same enhancement layer in a previously coded frame;

a module for calculating a sum of prediction residuals of the current block from all of lower layers; and

a module for forming a reference block for coding said enhancement layer by adding said sum of prediction residuals to said prediction.

The present invention provides a decoder for decoding an encoded digital video sequence to generate discrete-base layer frames and plurality of enhancement layer frames, each said frames comprising an array of pixels divided into a plurality of blocks.

The decoder comprises:

a module for determining a prediction for coding an enhancement layer of a current block of a current frame based on both a reference block used for a collocated block of the current block at a discrete base layer and a reference block for the current block at a same enhancement layer in a previously coded frame;

a module for calculating a sum of prediction residuals of the current block from all of lower layers; and

a module for forming a reference block for coding said enhancement layer by adding said sum of prediction residuals to said prediction.

The encoder and decoder as described above can be implemented in an electronic device such as a mobile phone.

Furthermore, the method for encoding and decoding as described above can be implemented in a software application product. Typically, the software application product has a computer readable storage medium having a software application for use in encoding a digital video sequence or decoding an encoded digital video sequence, the software application has programming codes to carry out the encoding and decoding method as described above.

Thus, although the present invention has been described with respect to one or more embodiments thereof, it will be understood by those skilled in the art that the foregoing and various other changes, omissions and deviations in the form and detail thereof may be made without departing from the scope of this invention.

What is claimed is:

1. A method of encoding a frame of a digital video sequence to generate discrete-base layer frames and a plurality of enhancement layer frames, each said frames comprising an array of pixels divided into a plurality of blocks, said method comprising:
determining a prediction for coding an enhancement layer of a current block of a current frame based on both a reference block used for a collocated block of the current block at a discrete base layer and a reference block for the current block at a same enhancement layer in a previously coded frame.

2. The method of claim 1, further comprising:
calculating a sum of prediction residuals of the current block from all of lower layers; and
forming a reference block for coding said enhancement layer by adding said sum of prediction residuals to said prediction.

3. The method of claim 1, wherein the collocated block of the current block of the discrete base layer has one or more coefficients, and
if all of said one or more coefficients of the collocated block in the discrete base layer are zero, the prediction of the current block is calculated as a weighted average of the reference block in the discrete base layer and the reference block in the enhancement layer.

4. The method of claim 1, wherein the collocated block of the current block of the discrete base layer has one or more non-zero coefficients, and
if the number of non-zero coefficients in the collocated block in the discrete base layer exceeds a predetermined threshold, then all of said one or more coefficients in the current block use a single leaky factor, said leaky factor is determined based on the number of nonzero coefficients in the discrete base layer, and the prediction of the current block is a weighted average of the reference block in discrete base layer and the reference block in enhancement layer.

5. The method of claim 1, wherein the collocated block of the current block of the discrete base layer has one or more non-zero coefficients, and
if the number of non-zero coefficients in the collocated block in the discrete base layer is greater than zero and the number is below or equal to a predetermined threshold, the prediction is formed in transform coefficient domain as a weighted average of the transform coefficients of the reference block in the discrete base layer and the transform coefficients of the reference block in enhancement layer.

6. The method of claim 4, wherein said predetermined threshold value is 0.

7. A method of encoding a frame of a digital video sequence to generate discrete-enhancement frames based on discrete-base layer frames and plurality of non-discrete enhancement layer frames on top of the discrete-base layer frames, each said frames comprising an array of pixels divided into a plurality of blocks, said method comprising:
forming a prediction for a discrete-enhancement layer frame either from its discrete-base layer frame or any one of the lower enhancement layer frames; and
indicating in the bitstream if said prediction is formed from its discrete-base layer frame or one of the lower enhancement layer frames.

8. A method of decoding an encoded digital video sequence to generate discrete-base layer frames and plurality of enhancement layer frames, each said frames comprising an array of pixels divided into a plurality of blocks, said method comprising:
determining a prediction for coding an enhancement layer of a current block of a current frame based on both a reference block used for a collocated block of the current block at a discrete base layer and a reference block for the current block at a same enhancement layer in a previously coded frame.

9. The method of claim 8, further comprising:
calculating a sum of prediction residuals of the current block from all of lower layers; and
forming a reference block for coding said enhancement layer by adding said sum of prediction residuals to said prediction.

10. The method of claim 8, wherein the collocated block of the current block of the discrete base layer has one or more coefficients, and
if all of said one or more coefficients of the collocated block in the discrete base layer are zero, the prediction of the current block is calculated as a weighted average of the reference block in the discrete base layer and the reference block in the enhancement layer.

11. The method of claim 8, wherein the collocated block of the current block of the discrete base layer has one or more non-zero coefficients, and
if the number of non-zero coefficients in the collocated block in the discrete base layer exceeds a predetermined threshold, then all of said one or more the coefficients in the current block use a single leaky factor, said leaky factor is determined based on the number of nonzero coefficients in the discrete base layer, and the prediction of the current block is a weighted average of the reference block in discrete base layer and the reference block in enhancement layer.

12. The method of claim 8, wherein the collocated block of the current block of the discrete base layer has one or more non-zero coefficients, and
if the number of non-zero coefficients in the collocated block in the discrete base layer is greater than zero and the number is below or equal to a predetermined threshold, the prediction is formed in transform coefficient domain as a weighted average of the transform coefficients of the reference block in the discrete base layer and the transform coefficients of the reference block in enhancement layer.

13. The method of claim 11, wherein said predetermined threshold value is 0.

14. A method of decoding an encoded digital video sequence to generate discrete-enhancement frames based on discrete-base layer frames and a plurality of non-discrete enhancement layer frames on top of the discrete-base layer frames, each said frames comprising an array of pixels divided into a plurality of blocks, said method comprising:
receiving in the bitstream an indication whether a prediction for coding an enhancement layer of a current block of a current frame is from a discrete-base layer frame or from one of the lower enhancement layer frames; and
forming a prediction for decoding the current discrete enhancement layer frame either from its discrete base layer frame or from one of the lower enhancement layer frames based on the received information.

15. An encoder for encoding a frame of a digital video sequence to generate discrete-base layer frames and a plurality of enhancement layer frames, each said frames comprising an array of pixels divided into a plurality of blocks, said encoder comprising:
a module for determining a prediction for coding an enhancement layer of a current block of a current frame based on both a reference block used for a collocated block of the current block at a discrete base layer and a reference block for the current block at a same enhancement layer in a previously coded frame.

16. The encoder of claim 15, further comprising:
a module for calculating a sum of prediction residuals of the current block from all of lower layers; and
a module for forming a reference block for coding said enhancement layer by adding said sum of prediction residuals to said prediction.

17. The encoder of claim 15, wherein the collocated block of the current block of the discrete base layer has one or more coefficients, and
if all of said one or more coefficients of the collocated block in the discrete base layer are zero, said calculating module is adapted to calculate the prediction of the current block as a weighted average of the reference block in the discrete base layer and the reference block in the enhancement layer.

18. The encoder of claim 15, wherein the collocated block of the current block of the discrete base layer has one or more non-zero coefficients, and
if the number of non-zero coefficients in the collocated block in the discrete base layer exceeds a predetermined threshold, then all of said one or more coefficients in the current block use a single leaky factor, said leaky factor is determined based on the number of nonzero coefficients in the discrete base layer, and the prediction of the current block is a weighted average of the reference block in discrete base layer and the reference block in enhancement layer.

19. The encoder of claim 15, wherein the collocated block of the current block of the discrete base layer has one or more non-zero coefficients, and
if the number of non-zero coefficients in the collocated block in the discrete base layer is greater than zero and the number is below or equal to a predetermined threshold, the prediction is formed in transform coefficient domain as a weighted average of the transform coefficients of the reference block in the discrete base layer and the transform coefficients of the reference block in enhancement layer.

20. The encoder of claim 18, wherein said predetermined threshold value is 0.

21. An encoder for encoding a frame of a digital video sequence to generate discrete-enhancement frames based on discrete-base layer frames and plurality of non-discrete enhancement layer frames on top of the discrete-base layer frames, each said frames comprising an array of pixels divided into a plurality of blocks, said encoder comprising:
a module for forming a prediction for a discrete-enhancement layer frame either from its discrete-base layer frame or any one of the lower enhancement layer frames; and
a module for indicating in the bitstream if said prediction is formed from its discrete-base layer frame or one of the lower enhancement layer frames.

22. A decoder for decoding an encoded digital video sequence to generate discrete-base layer frames and plurality of enhancement layer frames, each said frames comprising an array of pixels divided into a plurality of blocks, said decoder comprising:
a module for determining a prediction for coding an enhancement layer of a current block of a current frame based on both a reference block used for a collocated block of the current block at a discrete base layer and a reference block for the current block at a same enhancement layer in a previously coded frame.

23. The decoder of claim 22, further comprising:
a module for calculating a sum of prediction residuals of the current block from all of lower layers; and
a module for forming a reference block for coding said enhancement layer by adding said sum of prediction residuals to said prediction.

24. The decoder of claim 22, wherein the collocated block of the current block of the discrete base layer has one or more coefficients, and
if all of said one or more coefficients of the collocated block in the discrete base layer are zero, the prediction of the current block is calculated as a weighted average of the reference block in the discrete base layer and the reference block in the enhancement layer.

25. The decoder of claim 22, wherein the collocated block of the current block of the discrete base layer has one or more non-zero coefficients, and
if the number of non-zero coefficients in the collocated block in the discrete base layer exceeds a predetermined threshold, then all of said one or more of the coefficients in the current block use a single leaky factor, said leaky factor is determined based on the number of nonzero coefficients in the discrete base layer, and the prediction of the current block is a weighted average of the reference block in discrete base layer and the reference block in enhancement layer.

26. The decoder of claim 8, wherein the collocated block of the current block of the discrete base layer has one or more non-zero coefficients, and
if the number of non-zero coefficients in the collocated block in the discrete base layer is greater than zero and the number is below or equal to a predetermined threshold, the prediction is formed in transform coefficient domain as a weighted average of the transform coefficients of the reference block in the discrete base layer and the transform coefficients of the reference block in enhancement layer.

27. The decoder of claim 25, wherein said predetermined threshold value is 0.

28. A decoder of decoding an encoded digital video sequence to generate discrete-enhancement frames based on discrete-base layer frames and a plurality of non-discrete enhancement layer frames on top of the discrete-base layer frames, each said frames comprising an array of pixels divided into a plurality of blocks, wherein the decoder is configured for receiving in the bitstream an indication whether a prediction for coding an enhancement layer of a current block of a current frame is from a discrete-base layer frame or from one of the lower enhancement layer frames, said decoder comprising:
a module forming a prediction for decoding the current discrete enhancement layer frame either from its discrete base layer frame or from one of the lower enhancement layer frames based on the received information.

29. A device comprising:
an encoder and a decoder for encoding and decoding a frame of a digital video sequence to generate discrete-base layer frames and a plurality of enhancement layer frames, each said frames comprising an array of pixels divided into a plurality of blocks, wherein the encoder comprises:
a module for determining a prediction for coding an enhancement layer of a current block of a current frame based on both a reference block used for a collocated block of the current block at a discrete base layer and a reference block for the current block at a same enhancement layer in a previously coded frame; and
the decoder comprises:
a module for determining a prediction for coding an enhancement layer of a current block of a current frame based on both a reference block used for a collocated block of the current block at a discrete base layer and a reference block for the current block at a same enhancement layer in a previously coded frame.

30. The device of claim 29, comprising a mobile terminal.

31. A software application product comprising a computer readable storage medium having a software application for use in encoding a frame of a digital video sequence to generate discrete-base layer frames and a plurality of enhancement layer frames, each said frames comprising an array of pixels divided into a plurality of blocks, said software application comprising:
programming code for determining a prediction for coding an enhancement layer of a current block of a current frame based on both a reference block used for a collocated block of the current block at a discrete base layer and a reference block for the current block at a same enhancement layer in a previously coded frame;
programming code for calculating a sum of prediction residuals of the current block from all of lower layers; and
programming code for forming a reference block for coding said enhancement layer by adding said sum of prediction residuals to said prediction.

32. A software application product comprising a computer readable storage medium having a software application for use in decoding an encoded digital video sequence to generate discrete-base layer frames and plurality of enhancement layer frames, each said frames comprising an array of pixels divided into a plurality of blocks, said software application comprising:
programming code for determining a prediction for coding an enhancement layer of a current block of a current frame based on both a reference block used for a collocated block of the current block at a discrete base layer and a reference block for the current block at a same enhancement layer in a previously coded frame;
programming code for calculating a sum of prediction residuals of the current block from all of lower layers; and
programming code for forming a reference block for coding said enhancement layer by adding said sum of prediction residuals to said prediction.
